(19) United States
(12) Patent Application Publication
(10) Pub. No.: US 2025/0046861 A1
(43) Pub. Date: Feb. 6, 2025

(54) ELECTROLYTE COMPOSITION, ELECTRODE AND BATTERY

(71) Applicants: SUMITOMO CHEMICAL COMPANY, LIMITED, Tokyo (JP); Kyoto University, Kyoto (JP)

(72) Inventors: Atsunori DOI, Niihama-shi, Ehime (JP); Hideto NAKAJIMA, Niihama-shi, Ehime (JP); Satoru KUZE, Kyoto-shi, Kyoto (JP)

(21) Appl. No.: 18/717,633

(22) PCT Filed: Dec. 6, 2022
(86) PCT No.: PCT/JP2022/044944

§ 371 Date: Jun. 7, 2024

(30) Foreign Application Priority Data
Dec. 10, 2021 (JP) 2021-200915

(51) Int. Cl. H01M 10/0562; H01M 4/62; H01M 10/0525; H01M 10/42

(52) U.S. Cl. CPC H01M 10/0562; H01M 4/62; H01M 10/0525; H01M 10/4235; H01M 2300/0071; H01M 2300/008

(57) ABSTRACT

An electrolyte composition including: an inorganic solid electrolyte composed of a halide or an oxide; and a fibrillating resin, in which a content of the inorganic solid electrolyte is 65% by volume or more with respect to a total amount of the inorganic solid electrolyte and the fibrillating resin.

### TECHNICAL FIELD

The present disclosure relates to an electrolyte composition, an electrode, and a battery.

### BACKGROUND ART

Attention has been paid to solid electrolytes having ionic conductivity, such as solid electrolyte layers of lithium ion batteries. Unlike electrolytic solutions, solid electrolytes have advantages such as being non-flammable and safe, not generating gas as a result of decomposition of the solvent, and allowing expectation for possible capacity increase. In many cases, solid electrolytes are formed by integrating electrolyte materials to sintering, powder compacting, and the like, or by binding electrolyte materials using a binder such as a resin.

### CITATION LIST

### Patent Literature

Patent Literature 1: International Publication WO 2020/261758
Patent Literature 2: International Publication WO 2021/131716
Patent Literature 3: Specification of Chinese Patent Application Publication No. 112216863
Patent Literature 4: International Publication WO 2020/220697

### Non Patent Literature

Non Patent Literature 1: Chemical Engineering Journal 421 (2021) 129965
Non Patent Literature 2: Advanced Energy Materials, 2020, 10, 1903376

### SUMMARY OF INVENTION

### Technical Problem

However, in the case of a solid electrolyte formed by integrating electrolyte materials by sintering, powder compacting, or the like, since ionic conduction depends on the contact at the interfaces between electrolyte powder particles within the solid electrolyte, the barrier to ionic conduction is high, it is difficult to secure the contact at the interfaces with the electrodes, and it is difficult to cope with a variety of shapes. On the other hand, in an electrolyte layer using a binder, it is necessary to use a large amount of the binder in order to improve flexibility of the electrolyte layer, and the ionic conductivity tends to decrease.

The present disclosure is made in view of the above-described circumstances, and it is an object of the present disclosure to provide an electrolyte composition having high flexibility while maintaining ionic conductivity. Furthermore, it is another object of the present disclosure to provide an electrode and a battery that include such an electrolyte composition.

### Solution to Problem

An electrolyte composition of the present disclosure comprises an inorganic solid electrolyte composed of a halide or an oxide, and a fibrillating resin, wherein a content of the inorganic solid electrolyte is 65% by volume or more with respect to a total amount of the inorganic solid electrolyte and the fibrillating resin.

The inorganic solid electrolyte may be a halide.

A transport number of alkali metal ions may be 0.6 or more.

The fibrillating resin may be a fluorine-containing resin or an acrylic resin.

The fibrillating resin may be polytetrafluoroethylene.

The above-described inorganic solid electrolyte may be a lithium ion conductor.

The above-described halide may be a compound represented by

M^{A}_{α}M^{B}_{β}X₆ (1):

wherein in formula (1), 0<β≤1.1; for α, 1.6≤α≤3.5; M^{A} is an alkali metal; M^{B} is a metal element except alkali metals; and X is a halogen element.

A solid electrolyte of the present disclosure comprises the above-described electrolyte composition.

An electrode of the present disclosure comprises the above-described electrolyte composition and an active material.

A battery of the present disclosure comprises the above-described electrolyte composition.

### Advantageous Effects of Invention

According to the present disclosure, an electrolyte composition having high flexibility while maintaining ionic conductivity can be provided. Furthermore, according to the present disclosure, an electrode and a battery that include such an electrolyte composition can be provided.

### BRIEF DESCRIPTION OF DRAWINGS

FIG. 1 is a scanning electron microscopic photograph of an electrolyte composition of Example 1.

FIG. 2 is a scanning electron microscopic photograph of an electrolyte composition of Example 2.

FIG. 3 is a scanning electron microscopic photograph of an electrolyte composition of Example 3.

FIG. 4 is a scanning electron microscopic photograph of an electrolyte composition of Example 4.

FIG. 5 is a scanning electron microscopic photograph of an electrolyte composition of Example 5.

FIG. 6 is a scanning electron microscopic photograph of an electrolyte composition of Comparative Example 4.

FIG. 7 is a scanning electron microscopic photograph of an electrolyte composition of Comparative Example 5.

### DESCRIPTION OF EMBODIMENTS

The electrolyte composition according to an embodiment of the present disclosure contains: an inorganic solid electrolyte composed of a halide (halide solid electrolyte) or an oxide (oxide solid electrolyte); and a fibrillating resin, in which a content of the inorganic solid electrolyte is 65% by volume or more with respect to a total amount of the inorganic solid electrolyte and the fibrillating resin. According to such an electrolyte composition, an electrolyte composition having high flexibility while maintaining the ionic conductivity of the electrolyte composition, can be provided.

The inorganic solid electrolyte may contain an alkali metal. That is, the inorganic solid electrolyte may be an alkali metal-containing halide or an alkali metal-containing oxide. Such an inorganic solid electrolyte tends to have high conductivity for alkali metal ions. Particularly, the inorganic solid electrolyte of the present embodiment may be an alkali-containing halide, from the viewpoint of easily forming an interface and exhibiting high ionic conductivity. Examples of the alkali metal contained in the inorganic solid electrolyte include lithium, sodium, and potassium, and the alkali metal may be lithium. That is, the inorganic solid electrolyte may be a lithium ion conductor, a sodium ion conductor, or a potassium ion conductor, and may be a lithium ion conductor.

Examples of the alkali metal-containing halide include compounds containing an alkali metal, a metal element except alkali metals, and halogen. The molar content percentage of the alkali metal in the alkali metal-containing halide may be 20 mol % to 40 mol %, or may be 25 mol % to 35 mol %. Furthermore, the molar content percentage of halogen element may be 50 mol % to 70 mol %, or may be 55 mol % to 65 mol %. According to the present specification, unless particularly stated otherwise, the molar content percentage of each element is a molar content percentage with respect to the total number of atoms (moles) contained in the compound.

The alkali metal-containing halide may be, for example, a compound represented by the following compositional formula (1).

M^{A}_{α}M^{B}_{β}X₆ (1):

Here, M^{A} is an alkali metal; M^{B} is a metal element except alkali metals; and X is halogen element. α and β may be selected such that the charge of the compound as a whole becomes neutral; however, for example, in formula (1), β may be such that 0<β≤1.1, 0.5≤β≤1, or 0.8≤β≤1. α may be such that 1.6≤α≤3.5.

Examples of the alkali metal contained in the alkali metal-containing halide include lithium, sodium, and potassium, and the alkali metal may be lithium.

The halogen element contained in the alkali metal-containing halide may be any of fluorine, chlorine, bromine, and iodine; however, the halogen element may be at least one of chlorine, bromine, and iodine, may be at least one of chlorine and bromine, or may be chlorine.

The molar content percentage of the metal element except alkali metals may be 15 mol % or less, or may be 3 mol % to 12 mol %. The metal element except alkali metals may be a divalent or higher valent metal element, or may be a divalent to tetravalent metal atom. More specifically, examples of the metal element except alkali metals include alkaline earth metals, transition metals, rare earth elements, and p-block metal elements, and specifically, the metal element may be at least one element selected from the group consisting of Al, Ga, In, Sc, La, Y, Zr, Sn, Nb, Ta, Bi, Zr, Sm, Sb, Ti, and Hf, may be at least one element selected from the group consisting of In, Zr, and Y, or may be at least one of In and Zr. M^{B} may include In. M^{B} may include Zr.

The alkali metal-containing halide may have a monoclinic or trigonal crystal structure.

The alkali metal-containing halide may be such that at least either the metal element except alkali metals or the halogen element includes two or more kinds of elements.

When the alkali metal-containing halide includes two or more kinds of halogen elements, the combination of halogen elements may be any combination, and the molar ratio between the halogen elements may also be any ratio. For example, among the compounds represented by compositional formula (1), an example including two or more kinds of halogen elements may be a compound represented by the following compositional formula (2).

M^{A}_{α}M^{B1}_{β}Cl_{6-γ}X1_{γ} (2)

Here, in formula (2), X1 is a halogen element except chlorine, may be bromine or iodine, or may be bromine. γ may be such that 0≤γ<1, 0.01≤γ≤0.8, 0.02≤γ≤0.7, 0.1≤γ≤0.6, or 0.2≤γ≤0.6. M^{A}, M^{B}, α, and β have the same meanings as those in formula (1).

When the alkali metal-containing halide includes two or more kinds of metal elements except alkali metals, the metal elements except alkali metals may include only elements of the same valence, or may include elements of different valences. The molar ratio between the metal elements except alkali metals may be any ratio. An example of an alkali metal-containing halide containing two or more kinds of metal elements except alkali metals, may be a compound represented by the following compositional formula (3).

M^{A}_{α}M^{B1}_{δ}M^{B2}_{ε}X₆ (3)

M^{B1} and M^{B2}ε each is a metal element except alkali metals, and are metal elements different from each other. M^{B1} may be, for example, an element occupying 70 mol % or more, or 80 mol % to 99 mol %, among the metal elements except alkali metals included in the alkali metal-containing halide. M^{B1} may be at least one element selected from the group consisting of Al, Ga, In, Sc, La, Y, Zr, Ti, and Hf, or may be In, Zr, or Y. The content of M^{B2} may be an element occupying 30 mol % or less, or 1 mol % to 20 mol %, among the metal elements except alkali metals included in the alkali metal-containing halide. M^{B2} may be specifically Bi, Zn, Zr, Sn, Nb, Ta, or the like. δ and ε may be such that 0<δ+ε23 1.1, 0.5≤δ+ε≤1, or 0.8≤δ+ε≤1. M^{A}, α, and X have the same meanings as those in formula (1).

The alkali metal-containing halide may be a compound represented by the following compositional formula (5).

M^{A}_{α}M^{B1}_{δ}M^{B2}_{ε}Cl_{6-γ}X_{1γ} (5)

M^{A}, M^{B1}, M^{B1}, X1, α, γ, δ, and ε have the same meanings as those in formulas (2) and (3).

Examples of the alkali metal-containing halide include Li₃InCl₆, Li₃YCl₆, Li₂ZrCl₆, Li₃InBr₆, Li₃YBr₆, Li₂ZrCl_{5.95}Br_{0.05}, Na₃YCl₆, and Na₃YBr₆.

A method for producing the alkali metal-containing halide is not particularly limited; however, the method may include a step of obtaining an alkali metal-containing halide by subjecting raw materials to ball milling. The raw materials are not particularly limited; however, a raw material including an alkali metal may be an alkali metal halide such as lithium chloride. These raw materials can be selected as appropriate so as to obtain an intended composition of the alkali metal-containing halide.

The conditions for ball milling are not particularly limited, but can be set to 10 to 100 hours at a rotation speed of 200 to 700 rpm. The pulverization time may be 24 hours to 72 hours, or may be 36 to 60 hours.

The ball used for ball milling is not particularly limited; however, zirconia balls can be used. The size of the balls used is not particularly limited; however, balls having a size of 2 mm to 10 mm can be used.

By performing ball milling for the above-described time, each raw material is sufficiently mixed, a mechanochemical reaction is promoted, and as a result, it is possible to improve the ionic conductivity of the resulting compound.

Examples of the alkali metal-containing oxide include oxides containing an alkali metal and a metal element except alkali metals. Examples of the alkali metal include lithium, sodium, and potassium, and the alkali metal may be lithium. Examples of the metal element except alkali metals include an alkaline earth metal element, a rare earth element, a transition metal element (including zinc group), and a p-block metal element of the Periodic Table of Elements.

The alkaline earth metal element may be at least one selected from the group consisting of Be, Mg, Ca, Sr, and Ba, may be at least one selected from the group consisting of Mg, Ca, and Sr, or may be Sr.

The rare earth element may be Sc, Y, or a lanthanoid, or may be any one selected from the group consisting of Sc, Y, La, and Nd.

The transition metal element may be a transition metal element of the fourth period to the sixth period in the Periodic Table, may be at least one selected from the group consisting of Zr, Ta, Ti, V, Sb, and Nb, or may be at least one selected from the group consisting of Zr, Ta, and Nb.

The alkali metal-containing oxide may include a chalcogen (excluding oxygen), a halogen, or a non-metallic element such as an element of Group 15 (nitrogen group) in the Periodic Table, an element of Group 14 (carbon group) in the Periodic Table, or an element of Group 13 (boron group) in the Periodic Table. The non-metallic element may be fluorine.

The crystal structure of the alkali metal-containing oxide may be a garnet-type crystal structure, a perovskite-type crystal structure, a layered rock salt-type structure, a NASICON-type crystal structure, a LISICON-type crystal structure, an olivine-type crystal structure, or the like; however, the alkali metal-containing oxide may also be amorphous. The garnet-type crystal structure may be cubic or tetragonal.

Examples of an alkali metal-containing oxide having the garnet-type crystal structure include Li₂La₃Zr₂O₁₂, Li₂La₃Nb₂O₁₂, and Li₅BaLa₂TaO₁₂, and garnet-like crystals in which some of the elements in these compounds have been substituted with at least one element selected from the group consisting of N, F, Al, Sr, Sc, Nb, Ta, Sb, and lanthanoid elements, can also be used as the above-described alkali metal-containing oxide. Examples of an alkali metal-containing oxide having the perovskite-type crystal structure include Li_{0.35}La_{0.55} TiO₃ and Li_{0.2}La_{0.27}NbO₃, and perovskite-like crystals in which some of the elements in these compounds have been substituted with at least one element selected from the group consisting of N, F, Al, Sr, Sc, Nb, Ta, Sb, and lanthanoid elements, can also be used as the alkali metal-containing oxide. Examples of an alkali metal-containing oxide having the NASICON-type crystal structure include Li_{1.3}Ti_{1.7}Al_{0.3}(PO₄)₃, Li_{1.4}Al_{0.4}Ti_{1.6} (PO₄)₃, and Li_{1.4}Al_{0.4}Ti_{1.4}Ge_{0.2} (PO₄)₃, and NASICON-like crystals in which some of the elements in these compounds have been substituted with at least one element selected from the group consisting of N, F, Al, Sr, Sc, Nb, Ta, Sb, and lanthanoid elements, can also be used as the alkali metal-containing oxide. Examples of an alkali metal-containing oxide having LISICON-type crystals include Li₁₄ZnGe₄O₁₆, and LISICON-like crystals in which some of the elements in these compounds have been substituted with at least one element selected from the group consisting of N, F, Al, Sr, Sc, Nb, Ta, Sb, and lanthanoid elements, can also be used as the alkali metal-containing oxide. The alkali metal-containing oxide may also have other crystal structures such as Li_{3.4}V_{0.6}Si_{0.4}O₄, Li_{3.6}V_{0.4}Ge_{0.6}O₄, and Li₂₊ₓC₁₋ₓBₓO₃. Examples of an oxide containing sodium include a Na₃Zr₂Si₂PO₁₂ solid electrolyte having a NASICON-type structure, and a β-alumina solid electrolyte (Na₂O-11Al₂O₃).

A method for producing an alkali metal-containing oxide is not particularly limited, and may be a method including a step of calcining raw materials. The raw materials are not particularly limited, and examples of raw materials including alkali metals include oxides and carbonates of alkali metals. Examples of raw materials containing metal elements except alkali metals include oxides and carbonates including those metals. When a portion of the alkali metal-containing oxide is substituted with fluorine or the like, examples of a raw material containing fluorine include a metal fluoride. The metal fluoride may be calcined together with other raw materials, or a substitution reaction may be carried out by mixing an alkali metal-containing oxide obtained by calcining other raw materials, with a metal fluoride, and heating the mixture.

The electrolyte composition of the present embodiment includes a fibrillating resin as a binder. A fibrillating state refers to a state in which a polymer is in a fibrous form. A fibrillating resin is easily fiberized by a shear force occurring when mixing with an inorganic solid electrolyte, or when forming an electrolyte layer of a battery or the like. In the electrolyte composition of the present embodiment, a fibrillated resin having a length of 10 μm or more may be included.

Examples of the fibrillating resin include a fluorine-containing resin and an acrylic resin.

The fluorine-containing resin may be a resin having a carbon chain as the main chain. Examples of such a resin may be a homopolymer or copolymer having a chemical structure obtainable by polymerizing a monomer having an ethylenically unsaturated group and a fluorine atom. Specific examples thereof include polytetrafluoroethylene (PTFE), a tetrafluoroethylene-perfluoroalkyl vinyl ether copolymer (PFA), a tetrafluoroethylene-hexafluoropirubilene copolymer (FEP), a tetrafluoroethylene-ethylene copolymer (ETFE), polychlorotrifluoroethylene (PCTFE), a chlorotrifluoroethylene-ethylene copolymer (ECTFE), polyvinylidene fluoride (PVDF), poly(vinylidene fluoride-co-hexafluoropropylene) (PVDF-HFP), and polyvinyl fluoride (PVF). Furthermore, PTFE modified with an acrylic resin may also be used. Examples of the PTFE modified with an acrylic resin include METABLEN (registered trademark) type A manufactured by Mitsubishi Chemical Corporation. The electrolyte composition may contain one kind or two or more kinds among these resins.

Examples of a fibrillating acrylic resin include the resins disclosed in Japanese Unexamined Patent Publication No. S48-56925, Japanese Unexamined Patent Publication No. 2000-73229, and the like. Specifically, a resin containing an acrylonitrile-based polymer (acrylonitrile-based resin) may be used. Examples of the acrylonitrile-based polymer include copolymers of acrylonitrile and other monomers having an ethylenically unsaturated group. The content percentage of a unit derived from (meth)acrylonitrile (unit obtained by radical addition polymerization of acrylonitrile) in the copolymer may be 80% by mass or more. Furthermore, examples of the other monomer having an ethylenically unsaturated group include an alkyl (meth)acrylic acid ester such as methyl (meth)acrylate, (meth)acrylic acid, methacrylonitrile, (meth)acrylamide, vinyl chloride, vinyl bromide, vinyl fluoride, vinylidene chloride, vinylidene bromide, styrene, styrene sulfonic acid, allyl sulfonic acid, methallyl sulfonic acid, styrene sulfonate, allyl sulfonate, methallyl sulfonate, ethylene, propylene, and vinyl acetate, and only one kind or two or more kinds of these may be used. Examples of the fibrillating acrylic resin include a resin containing two kinds or two or more kinds of acrylonitrile-based polymers having different content percentages of the units derived from acrylonitrile, and a resin containing 50% to 80% by mass of an acrylonitrile-based polymer and 20% to 50% by mass of a poly(meth)acrylic acid ester, and the internal moisture content may be 130% to 300% by mass. Examples of the poly(meth)acrylic acid ester include homopolymers such as polymethyl (meth)acrylate. Incidentally, regarding an internal moisture percentage, the internal moisture percentage is calculated by using the following formula, from mass A obtained after dehydrating the resin at an acceleration of 1000 G for 2 minutes, and mass B obtained after further bone-drying the fibers of the resin.

Internal moisture percentage (% by mass)=[(A−B)/B]×100

According to the present specification, the acrylic resin is a resin containing at least one kind of unit derived from a (meth)acrylic acid derivative such as (meth)acrylic acid, (meth)acrylic acid ester, (meth)acrylonitrile, or (meth)acrylamide, and may also be a mixture of polymers. Similarly, the acrylonitrile-based polymer is a resin containing a polymer having a unit derived from (meth)acrylonitrile (acrylonitrile-based polymer). Furthermore, the term (meth)acrylic acid according to the present specification refers to both acrylic acid and (meth)acrylic acid, and the same also applies to the term (meth)acrylic acid derivatives, such as (meth)acrylic acid ester, (meth)acrylonitrile, and (meth)acrylamide.

From the viewpoint of increasing ionic conductivity, the content of the inorganic solid electrolyte may be 70% by volume or more, may be 75% by volume or more, or may be 80% by volume or more, with respect to the total amount of the inorganic solid electrolyte and the fibrillating resin. Furthermore, from the viewpoint of ensuring the binding strength of the binder, the content of the inorganic solid electrolyte may be 99.9% by volume or less, or may be 99.5% by volume or less, with respect to the total amount of the inorganic solid electrolyte and the fibrillating resin. From the viewpoint of increasing ionic conductivity, the content of the inorganic solid electrolyte may be 65% to 99.9% by volume, may be 70% to 99.9% by volume, may be 75% to 99.5% by volume, or may be 80% to 99.5% by volume, with respect to the total amount of the inorganic solid electrolyte and the fibrillating resin.

The total amount of the inorganic solid electrolyte and the fibrillating resin in the electrolyte composition may be 70% by mass or more, may be 80% by mass or more, may be 90% by mass or more, or may be 95% by mass or more, with respect to the total amount of the electrolyte composition.

Examples of components other than the inorganic solid electrolyte and the fibrillating resin in the electrolyte composition include an organic solvent, and alkali metal salts such as LiPF₆ and LiBF₄.

The transport number of alkali metal ions in the electrolyte composition of the present embodiment may be 0.60 or more, may be 0.65 or more, may be 0.7 or more, or may be 0.8 or more. The transport number may be a transport number measured at room temperature (25° C.).

Since the electrolyte composition of the present embodiment has high ionic conductivity and is flexible, the electrolyte composition can be used in various use applications as an ion-conducting material. For example, in a battery such as a lithium ion battery having a positive electrode, a negative electrode, and an electrolyte (electrolyte layer) interposed between the positive electrode and the negative electrode, the electrolyte composition can be used as a material for each of the positive electrode, the negative electrode, and the electrolyte, or may be used as a material for the positive electrode or the electrolyte layer.

When used as an electrolyte layer (solid electrolyte) of a battery, the electrolyte composition may be used as a formed body obtained by forming the electrolyte composition into a predetermined shape. Forming may be carried out by pressure forming or the like.

The electrolyte layer may include a plurality of layers. For example, a configuration including a sulfide solid electrolyte layer in addition to the electrolyte layer of the present embodiment may be adopted. A configuration having a sulfide solid electrolyte layer between the electrolyte of the present embodiment and a negative electrode may be adopted. The sulfide solid electrolyte is not particularly limited; however, examples thereof include Li₆PS₅Cl, Li₂S—PS₅, Li₁₀GeP₂S₁₂, Li_{9.6}P₃S₁₂, Li_{9.54}Si_{1.74}P_{1.44}S_{11.7}Cl_{0.3}, and Li₃PS₄.

When the electrolyte composition of the present embodiment is used as a material for an electrode, the electrolyte composition is mixed with an active material and then used. That is, an electrode of the present embodiment contains the above-described electrolyte composition and an active material.

When the electrode is a positive electrode, the positive electrode contains the above-described electrolyte composition and a positive electrode active material. The positive electrode may contain, in addition to the electrolyte composition and the positive electrode active material, a conductive aid and the like as necessary. The positive electrode may be one in which a layer containing these materials is formed on a current collector. Examples of the positive electrode active material include lithium-containing composite metal oxides containing lithium (Li) and at least one transition metal selected from the group consisting of V, Cr, Mn, Fe, Co, Ni, and Cu. Examples of such a lithium composite metal oxide LiCoO₂, LiNiO₂, LiMn₂O₄, Li₂MnO₃, LiNiₓMn_{y}Co_{1-x-y}O₂[0<x+y<1]), LiNiₓCo_{y}Al_{1-x-y}O₂[0<x+y<1]), LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

The negative electrode of a lithium ion battery is not particularly limited and may be one that contains a negative electrode active material and contains a conductive aid, a binder, and the like as necessary. Examples of the negative electrode active material include metals and alloys containing these metals, such as Li, Si, Sn, Si—Mn, Si—Co, Si—Ni, In, and Au, carbon materials such as graphite, and materials in which lithium ions are intercalated between layers of the carbon materials.

The material of the current collector is not particularly limited and may be a simple substance or an alloy of metals such as Cu, Mg, Ti, Fe, Co, Ni, Zn, Al, Ge, In, Au, Pt, Ag, and Pd.

A battery of the present embodiment contains the above-described electrolyte composition as the material of at least one of a positive electrode, a negative electrode, and an electrolyte. When an electrode or the electrolyte of the battery contains the above-described electrolyte composition, the fibrillating resin is fibrillated in the electrode or the electrolyte.

### EXAMPLES

### Example 1

In an argon atmosphere having a dew point of −70° C. or lower (hereinafter, described as a dry argon atmosphere), LiCl and InCl₃ were weighed, and raw materials were prepared.

The raw materials were mechanochemically reacted by using a planetary ball milling apparatus (manufactured by Verder Scientific GmbH & Co. KG, PM400), and Li₃InCl₆ (feed composition) was obtained. Specifically, first, the above-described raw materials were put into a zirconia pot having a volume of 50 ml for planetary ball milling, and 65 g of zirconia balls having a diameter of 4 mm were introduced therein. The above-described compound was obtained by performing ball milling by using the planetary ball milling apparatus under the conditions of 48 hours and 380 rpm.

Ball milling was carried out in a mode in which every time the apparatus was rotated for 10 minutes, the apparatus was stopped for 1 minute as an interval, and the direction of rotation was alternately switched between clockwise and counterclockwise.

For the obtained Li₃InCl₆, the crystal structure was evaluated by powder X-ray diffraction measurement at 25° C. Regarding the measurement conditions for the powder X-ray diffraction measurement, the measurement was carried out under the following conditions. Measuring apparatus: Ultima IV (manufactured by Rigaku Corporation)

X-ray generator: CuKα radiation source, voltage 40 kV, current 40 mA

X-ray detector: Semiconductor detector

Measurement range: Diffraction angle 20=10° to 80°

Scan speed: 4°/min

As a result of the analysis, the crystal structure was assigned to the monoclinic space group C2/m.

The obtained Li₃InCl₆ and polytetrafluoroethylene (PTFE, manufactured by Chemours-Mitsui Fluoroproducts Co., Ltd., trade name: Fine Powder 6-J) were mixed at proportions of 96:4 in volume ratio by hand milling using an agate mortar, and an electrolyte composition was obtained.

### Example 2

An electrolyte composition was produced in the same manner as in Example 1, except that Li₃InCl₆ and PTFE were mixed at proportions of 83:17 in volume ratio.

### Example 3

An electrolyte composition was produced in the same manner as in Example 1, except that Li₃InCl₆ was changed to Li_{6.6}La₃Zr_{1.6} Ta_{0.4}O₁₂ (LLZT, manufactured by TOSHIMA Manufacturing Co., Ltd.), which is a garnet-type oxide solid electrolyte, and LLZT and PTFE were mixed at proportions of 99:1 in volume ratio.

### Example 4

An electrolyte composition was produced in the same manner as in Example 1, except that Li₃InCl₆ and PTFE were mixed at proportions of 99:1 in volume ratio.

### Example 5

LiCl, LiBr, and ZrCl₄ were weighed under the same conditions as in Example 1, and raw materials were prepared. The raw materials were mechanochemically reacted in the same manner as in Example 1 by using a planetary ball milling apparatus (manufactured by Verder Scientific GmbH & Co. KG, PM400), and Li₂ZrCl_{5.95}Br_{0.05} (feed composition) was obtained.

The obtained Li₂ZrCl_{5.95}Br_{0.05}, the crystal structure was evaluated by powder X-ray diffraction measurement at 25° C. under the above-described conditions.

As a result of the analysis, the crystal structure was assigned to the trigonal space group P-3 ml.

The obtained Li₂ZrCl_{5.95}Br_{0.05} and polytetrafluoroethylene (PTFE, manufactured by Chemours-Mitsui Fluoroproducts Co., Ltd., trade name: Fine Powder 6-J) were mixed at proportions of 96:4 in volume ratio by hand milling using an agate mortar, and a pellet-shaped electrolyte composition was obtained.

### Comparative Example 1

A green compact obtained by powder compacting Li₃InCl₆ produced in the same manner as in Example 1 without adding a resin, was used.

### Comparative Example 2

A green compact obtained by powder compacting LLZT produced in the same manner as in Example 1 without adding a resin, was used.

### Comparative Example 3

An electrolyte composition was produced in the same manner as in Example 1, except that Li₃InCl₆ and PTFE were mixed at proportions of 63:37 in volume ratio.

### Comparative Example 4

An electrolyte composition was produced in the same manner as in Example 3, except that LLZT and poly(ethylene oxide) (PEO) were mixed at proportions of 10:90 in volume ratio. The PEO used was not fibrillated. The information on the PEO used is as follows.
Reagent manufacturer: Aldrich, product number: 181986
Product name: poly(ethylene oxide), average Mv 100000, powder

### Comparative Example 5

An electrolyte composition was produced in the same manner as in Comparative example 4, except that LLZT and poly(ethylene oxide) (PEO) were mixed at proportions of 90:10 in volume ratio.

Various measurements were performed for each electrolyte material of the electrolyte compositions, green compacts and sintered bodies of electrolytes obtained in Examples 1 to 5 and Comparative Examples 1 to 5.

### <Measurement of Ionic Conductivity>

A pressure forming die equipped with a frame mold, a lower punch, and an upper punch was prepared. The frame mold was formed of an insulating polycarbonate. Furthermore, the upper punch and the lower punch were both formed of electronically conductive stainless steel and were each electrically connected to a terminal of an impedance analyzer (manufactured by Solatron Analytical, SI1260).

The ionic conductivity was measured by the following method, by using the above-described pressure forming die. First, in a dry argon atmosphere, each electrolyte material of Examples and Comparative Examples was filled on the upper punch inserted into the hollow portion of the frame mold vertically from below. Then, the upper punch was pressed from above into the hollow portion of the frame mold, and thereby a pressure of 200 MPa was applied to the electrolyte material inside the pressure forming die. After the pressure was applied, the punches were fastened from above and below with a jig to be fixed, and in a state in which a constant pressure was maintained, the impedance of the electrolyte material at 25° C. was measured by an electrochemical impedance measurement method by using the above-described impedance analyzer.

A graph of a Cole-Cole diagram was created from the impedance measurement results. In the Cole-Cole diagram, the real value of impedance at the measurement point where the absolute value of the phase of complex impedance was the smallest was regarded as the resistance value to ionic conduction of the electrolyte material. By using the resistance value, the ionic conductivity (025° C.) was calculated based on the following mathematical formula (III).

$$σ = {( {R}_{S E} \times S / t )}^{- 1} \qquad ( III )$$

Here,
σ is the ionic conductivity,
S is the contact area of the electrolyte material with the upper punch (equal to the cross-sectional area of the hollow portion of the frame mold),
R_{SE} is the resistance value of the electrolyte material in the impedance measurement, and
t is the thickness of the electrolyte material when pressure is applied.

### <Evaluation of Stress Resistance>

A formed body was produced by applying a uniaxial pressure of 37 MPa by using a cylindrical-shaped mold made of stainless steel, in which the inner diameter of the sample enclosure part was 10 mm. For the obtained formed body, the presence or absence of cracks in the formed body when a uniaxial pressure of 185 MPa was applied was checked in a state of being taken out from the mold. The results are shown in Table 1.

In Table 1, “No cracks” indicates that the electrolyte composition was clay-like and was plastically deformed, and therefore, a formed body without cracks was obtained. On the other hand, in Table 1, “Cracked” indicates that the electrolyte material cracked due to pressure, and an integrated formed body was not obtained.

### <Observation Using Scanning Electron Microscope (SEM)>

Observation was performed by using a scanning electron microscope JCM-7000 (manufactured by JEOL Ltd.). Observations were made under the conditions of an accelerating voltage of 15 kV and high vacuum mode.

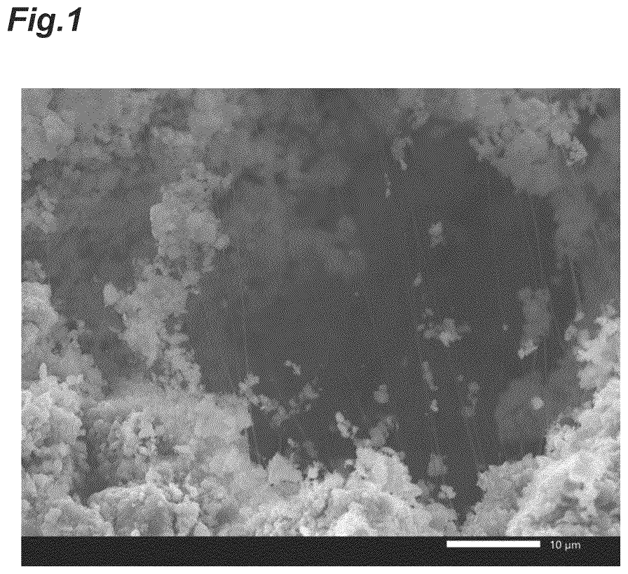

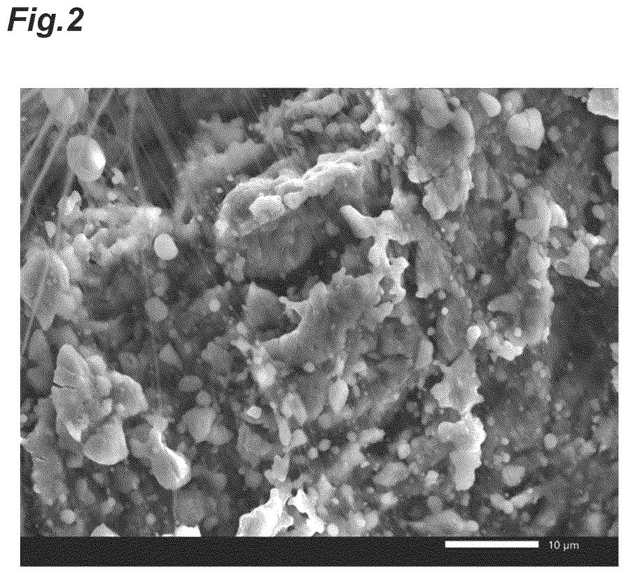

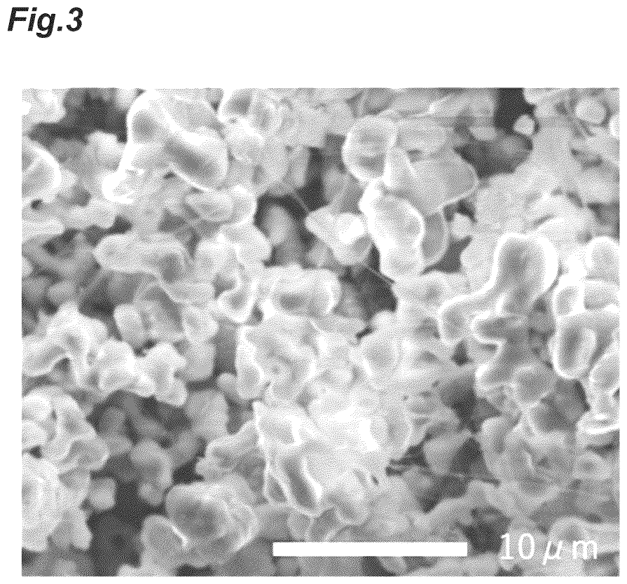

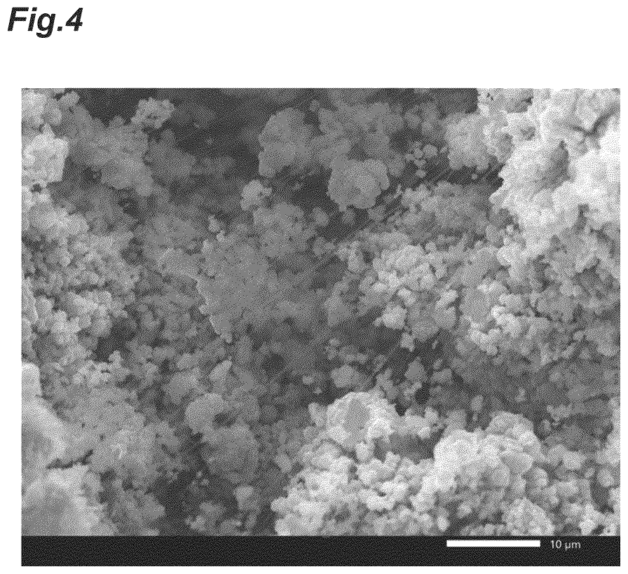

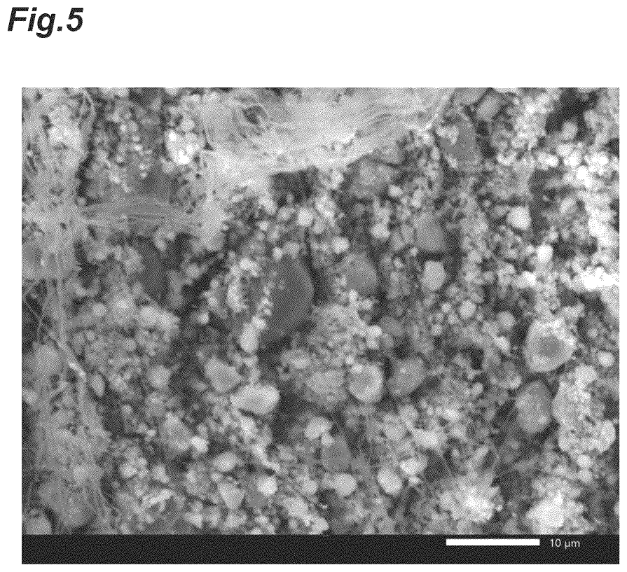

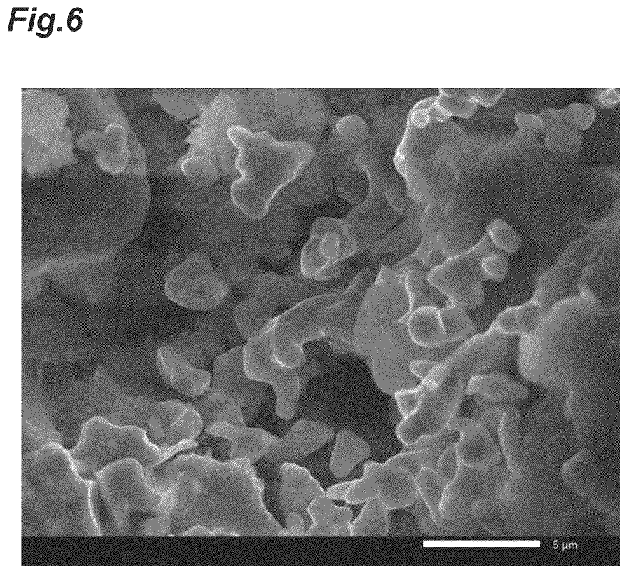

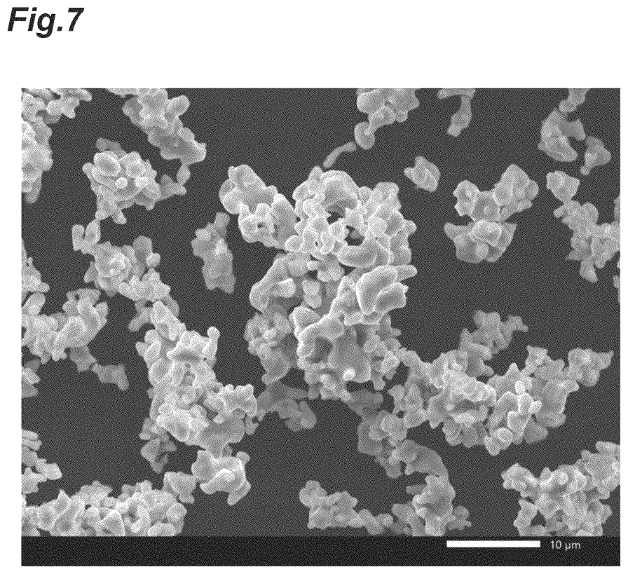

FIGS. 1 to 7 show SEM images of the electrolyte compositions of Examples 1 to 5 and Comparative Examples 4 and 5. As can be seen from FIGS. 1 to 5, PTFE was fibrillated to a length of 10 μm or more in the electrolyte compositions of Examples 1 to 5. On the other hand, as shown in FIGS. 6 and 7, PEO was not fibrillated in the electrolyte compositions of Comparative Examples 4 and 5.

### <Measurement of Lithium Ion Transport Number>

In a dry argon atmosphere, 100 mg of each of the electrolyte compositions of Examples 1 to 5 was put into an insulating cylinder having an inner diameter of 10 mm, a pressure of 200 MPa was applied thereto, and a first solid electrolyte layer was formed.

Next, 60 mg of a sulfide solid electrolyte, Li₆PS₅Cl, was placed on both the top side and the bottom side of the first solid electrolyte layer to be in contact with the first solid electrolyte layer, and a laminated body was obtained. A pressure of 200 MPa was applied to the laminated body, and second and third solid electrolyte layers were formed. The first solid electrolyte layer was interposed between the second solid electrolyte layer and the third solid electrolyte layer.

Next, 60 mg of In foil was placed to be in contact with each of the second and third solid electrolyte layers, 2 mg of Li foil was further placed to be in contact with the In foil, and a laminated body was obtained. A pressure of 200 MPa was applied to the laminated body, and first and second electrodes were formed.

Current collectors formed of stainless steel were attached to the first electrode and the second electrode, and next, lead wires were attached to the current collectors. All the members were arranged in a desiccator and tightly sealed, and in this way, a cell for measuring the transport number of the electrolyte composition was obtained.

A voltage of 10 mV was applied to the cell for measuring the transport number of the electrolyte composition at room temperature (25° C.), the initial current value (I₀) and the current value (Iₛₛ) after a lapse of 10000 seconds from the voltage application were measured, and the obtained values were substituted into the following formula to determine the lithium ion transport number (t_{Li+}).

$${t}_{L i +} = {I}_{s s} / {I}_{0}$$

### <Production of Coin Cell>

A coin cell was produced using the electrolyte composition produced in Example 1.

Specifically, in a dry argon atmosphere, 29 parts by mass of the electrolyte composition of Example 1, 67 parts by mass of LiNi_{1/3}Mn_{1/3}Co_{1/3}O₃, and 4 parts by mass of acetylene black were weighed out and mixed in a mortar to obtain a positive electrode material mixture.

6.2 mg of the obtained mixture was pressed against an aluminum mesh by using a pestle to apply pressure, and the mixture was adhered thereto to produce a positive electrode layer. With regard to the positive electrode layer, 150 mg of the electrolyte composition of Example 1 was disposed on the positive electrode layer, and a pressure of 110 MPa was applied thereto by using a uniaxial press to produce a solid electrolyte layer on the positive electrode layer. In addition, 60.5 mg of In metal and 2.3 mg of Li metal were placed on the solid electrolyte layer, a pressure of 110 MPa was applied thereto to integrate the layers, and thereby a negative electrode layer was formed. The laminated body in which the positive electrode layer, the solid electrolyte layer, and the negative electrode layer were integrated, was interposed between spacers made of SUS, placed in a coin case, and then caulked, and thereby a coin cell was produced.

### <Coin Cell Charge-Discharge Test>

A charge-discharge test was carried out by using the following product as a charge-discharge tester.

Charge-discharge tester: Toyo System Co., Ltd., TOSCAT-3100

The charge-discharge test was carried out at 60° C. at a C rate of 0.1 C.

The above-described coin cell was charged, by constant current constant voltage charging (CCCV charging), to 3.7 V at a current density corresponding to a C rate of 0.1 C.

Regarding discharging, the coin cell was discharged to 1.9 V at a current density corresponding to a C rate of 0.1 C.

As a result of the charge-discharge test, the charge capacity was 123 mAh/g, and the discharge capacity was 20 mAh/g.

On the other hand, coin cells were produced by similar methods in Comparative Example 1 and Comparative Example 2; however, the positive electrode layer and the solid electrolyte layer could not be formed, and a charge-discharge test could not be conducted.

### <Production of Pressed Powder Cell Secondary Battery>

In a dry argon atmosphere, 29 parts by mass of the electrolyte composition of Example 4, 67 parts by mass of LiNi_{1/3}Mn_{1/3}Co_{1/3}O₃, and 4 parts by mass of acetylene black were weighed out and mixed in a mortar to obtain a mixture.

In an insulating cylinder having an inner diameter of 10 mm, 100 mg of the electrolyte composition of Example 4 and 15 mg of the above-described mixture were laminated in this order to obtain a laminated body. A pressure of 200 MPa was applied to the laminated body, and a first electrode (a layer of the above-described mixture) and a first solid electrolyte layer (a layer of the electrolyte composition of Example 4) were formed.

Next, 60 mg of a sulfide solid electrolyte, Li₆PS₅Cl, was placed to be in contact with the first solid electrolyte layer, and a laminated body was obtained. A pressure of 200 MPa was applied to the laminated body, and a second solid electrolyte layer was formed. The first solid electrolyte layer was interposed between the first electrode and the second solid electrolyte layer.

Next, 60 mg of In foil was placed to be in contact with the second solid electrolyte layer, 2 mg of Li foil was further placed to be in contact with the In foil, and a laminated body was obtained. A pressure of 200 MPa was applied to the laminated body, and a second electrode was formed.

Current collectors formed of stainless steel were attached to the first electrode and the second electrode, and next, lead wires were attached to the current collectors. All the members were arranged in a desiccator and tightly sealed, and in this way, a pressed powder cell secondary battery of Example 4 was obtained.

### <Charge-Discharge Test for Pressed Powder Cell Secondary Battery>

For the obtained pressed powder cell secondary battery of Example 4, a charge-discharge test was carried out at 60° C.

The charge-discharge test was carried out at two C rates, at 0.1 C and 1 C.

The pressed powder cell secondary battery was charged, by constant current constant voltage charging (CCCV charging), to 3.7 V at a current density corresponding to each of the C rates. Regarding discharging, the pressed powder cell secondary battery was discharged to 1.9 V at a current density corresponding to each of the C rates.

As a result of the charge-discharge test, the discharge capacities at a C rate of 0.1 C and a C rate of 1 C were 171 mAh/g and 85 mAh/g, respectively.

TABLE 1

| | | Li⁺ transport | σ_{25° C.} | Stress |
|---|---|---|---|---|
| | Composition | number | (S/cm) | resistance |
| Example 1 | Li₃InCl₆/PTFE = 96/4 | 0.87 | 8.0 × 10⁻⁴ | No cracks |
| Example 2 | Li₃InCl₆/PTFE = 83/17 | 0.98 | 1.2 × 10⁻⁵ | No cracks |
| Example 3 | LLZT/PTFE = 99/1 | 0.99 | 1.0 × 10⁻⁷ | No cracks |
| Example 4 | Li₃InCl₆/PTFE = 99/1 | 0.97 | 6.6 × 10⁻⁴ | No cracks |
| Example 5 | Li₂ZrC_{15.95}Bro.₀₅/PTFE = 96/4 | 0.99 | 1.2 × 10⁻⁴ | No cracks |
| Comparative | Li₃InCl₆ | — | 1.2 × 10⁻³ | Cracked |
| Example 1 | | | | |
| Comparative | LLZT | — | 9.1 × 10⁻⁸ | Cracked |
| Example 2 | | | | |
| Comparative | Li₃InCl₆/PTFE = 63/37 | — | 1.3 × 10⁻⁸ | — |
| Example 3 | | | | |
| Comparative | LLZT/PEO = 10/90 | — | 3.1 × 10⁻¹² | No cracks |
| Example 4 | | | | |
| Comparative | LLZT/PEO = 90/10 | — | — | Cracked |
| Example 5 | | | | |

1. An electrolyte composition comprising:
an inorganic solid electrolyte composed of a halide or an oxide; and
a fibrillating resin,
wherein a content of the inorganic solid electrolyte is 65% by volume or more with respect to a total amount of the inorganic solid electrolyte and the fibrillating resin.

2. The electrolyte composition according to claim 1, wherein the inorganic solid electrolyte is a halide.

3. The electrolyte composition according to claim 1, wherein a transport number of alkali metal ions is 0.6 or more.

4. The electrolyte composition according to claim 1, wherein the fibrillating resin is a fluorine-containing resin or an acrylic resin.

5. The electrolyte composition according to claim 1, wherein the fibrillating resin is polytetrafluoroethylene.

6. The electrolyte composition according to claim 1, wherein the inorganic solid electrolyte is a lithium ion conductor.

7. The electrolyte composition according to claim 1, wherein the halide is represented by the following formula:
M^{A}_{α}M^{B}_{β}X₆ (1):
wherein in formula (1), 0<β≤1.1; for α, 1.6≤α≤3.5; M^{A} is an alkali metal; M^{B} is a metal element except alkali metals; and X is a halogen element.

8. A solid electrolyte comprising the electrolyte composition according to claim 1.

9. An electrode comprising:
the electrolyte composition according to claim 1; and
an active material.

10. A battery comprising the electrolyte composition according to claim 1.
